(19) United States
(12) Patent Application Publication
(10) Pub. No.: US 2023/0217891 A1
(43) Pub. Date: Jul. 13, 2023

(54) Pet Stroller with Entrance Arrangement

(71) Applicant: Yuanzhen Xiang, La Canada, CA (US)

(72) Inventor: Yuanzhen Xiang, La Canada, CA (US)

(21) Appl. No.: 17/571,422

(22) Filed: Jan. 7, 2022

(51) Int. Cl. A01K 1/02; B62B 7/06; B62B 5/00; B62B 3/02; B60P 1/43

(52) U.S. Cl. CPC A01K 1/0254; B62B 7/06; B62B 5/00; B62B 3/02; B60P 1/43

(57) ABSTRACT

A pet stroller includes a stroller frame and an entrance arrangement. The stroller frame includes a foldable frame, a boundary frame supported by the foldable frame, and a handle frame upwardly extended from the foldable frame, wherein the boundary frame includes a U-shaped boundary member defining a pet seating area and a front entrance. The entrance arrangement includes a front entrance member movably coupled at two front ends of the boundary member respectively to move between an uplift position and a drop down position. At the uplift position, the front entrance member is lifted upwardly to form a front boundary of the boundary frame for blocking the front entrance, and at the drop down position, the front entrance member is dropped down to enlarge the front entrance for accessing the pet seating area.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a stroller, and more particularly to a pet stroller with an entrance arrangement, wherein a front entrance is selectively enlarged for a pet easily getting in-and-out a pet resting area of the pet stroller.

### Description of Related Arts

Pet strollers are designed for walking small or medium sized pets, such as dogs or cats. The existing pet stroller generally comprises a stroller frame and a wheel base coupled at a bottom of the stroller frame. The stroller frame comprises a boundary frame having a seating area, a handle upwardly extended from the boundary frame, and a shading assembly coupled at the boundary frame to shade the seating area. However, the existing pet stroller has several drawbacks.

In order to put the pet in and out the seating area of the pet stroller, the pet owner must carry the pet over the boundary frame. It is a burden for the pet owner, especially a senior, to carry a relatively heavy pet over the boundary frame to place the pet in or put the seating frame of the pet stroller. Accordingly, the boundary frame is designed to elevate at a predetermined height from the ground to reduce a reaching distance between the pet owner and the pet at the seating area. However, there is no existing tool for allowing the pet easily to get in-and-out the boundary frame.

The shading assembly generally comprises a foldable shading awning coupled at the boundary frame above the seating area. However, the foldable shading awning can only fold between a shaded position to fully shade the seating area and an exposed position to fully expose the seating area. In other words, it is impossible to control a shading area for the seating area.

### SUMMARY OF THE PRESENT INVENTION

The invention is advantageous in that it provides a pet stroller with an entrance arrangement, wherein a front entrance is selectively enlarged for a pet easily getting in-and-out a pet resting area of the pet stroller.

Another advantage of the invention is to a pet stroller with an entrance arrangement, wherein a front entrance member is downwardly drop to enlarge the front entrance and is upwardly lifted to form a front boundary for blocking the front entrance.

Another advantage of the invention is to a pet stroller with an entrance arrangement, wherein the front entrance member is lockable between the drop down position and the uplift position to prevent the front entrance member being accessed accidentally or unintentionally.

Another advantage of the invention is to a pet stroller with an entrance arrangement, wherein the front entrance member is guided to slide between the drop down position and the uplift position via the guiding arms to ensure the folding movement of the front entrance member.

Another advantage of the invention is to a pet stroller with an entrance arrangement, wherein a step panel is received under the pet seating area when it is not in use and is frontwardly extended from the pet entrance for allowing the pet walking on the step panel from the ground to the pet seating area.

Another advantage of the invention is to a pet stroller with an entrance arrangement, wherein the step panel is selectively coupled at different points of the stroller frame to selectively adjust an inclined angle of the step panel from the ground to the pet entrance.

Another advantage of the invention is to a pet stroller with an entrance arrangement, wherein a handle portion of a handle frame is adjustable to enable the user to control the pet stroller in an ergonomic manner.

Another advantage of the invention is to a pet stroller with an entrance arrangement, wherein a rear wheel braking system is configured for controlling a rotation of the rear wheel so as to prevent any unwanted movement of the pet stroller when it is fully stopped.

Another advantage of the invention is to a pet stroller with an entrance arrangement, wherein a shading frame is configured to selectively expand the canopy to one of a full shading position for fully shading the pet resting area, a half shading position for partially shading the pet resting area, and an exposing portion for uncovering the pet resting area.

Another advantage of the invention is to a pet stroller with an entrance arrangement, wherein an entrance angle of the front entrance is controllable via an entrance control member.

Another advantage of the invention is to provide a pet stroller with an entrance arrangement, wherein the entrance arrangement is able to incorporate with any existing stroller frame for a pet easily getting in-and-out a pet resting area of the pet stroller.

Another advantage of the invention is to provide a pet stroller with an entrance arrangement, which does not require to alter the original structural design of the existing stroller frame, so as to minimize the manufacturing cost of the stroller frame incorporating with the entrance arrangement.

Another advantage of the invention is to provide a pet stroller with an entrance arrangement, wherein no expensive or complicated structure is required to employ in the present invention in order to achieve the above mentioned objects. Therefore, the present invention successfully provides an economic and efficient solution for well supporting the pet in the pet stroller and for the pet easily getting in-and-out a pet resting area of the pet stroller.

Additional advantages and features of the invention will become apparent from the description which follows, and may be realized by means of the instrumentalities and combinations particular point out in the appended claims.

According to the present invention, the foregoing and other objects and advantages are attained by a pet stroller which comprises a stroller frame and an entrance arrangement.

The stroller frame comprises a foldable frame, a boundary frame supported by the foldable frame, and a handle frame upwardly extended from the foldable frame, wherein the boundary frame includes a U-shaped boundary member defining a pet seating area and a front entrance.

The entrance arrangement comprises a front entrance member movably coupled at two front ends of the boundary member respectively to move between an uplift position and a drop down position. At the uplift position, the front entrance member is lifted upwardly to form a front boundary of the boundary frame for blocking the front entrance, and at the drop down position, the front entrance member is dropped down to enlarge the front entrance for accessing the pet seating area.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a pet stroller according to a preferred embodiment of the present invention.

FIG. 2 is a perspective view illustrating an entrance arrangement of the pet stroller at an uplift position according to the above preferred embodiment of the present invention.

FIG. 3 is a perspective view illustrating the entrance arrangement of the pet stroller at a drop down position according to the above preferred embodiment of the present invention.

FIG. 4 is partial perspective view illustrating a front entrance member of the entrance arrangement of the pet stroller at the uplift position according to the above preferred embodiment of the present invention.

FIG. 5 is side view illustrating the guiding arm of the entrance arrangement of the pet stroller at the drop down position according to the above preferred embodiment of the present invention.

FIG. 6 is a partial perspective view illustrating a frame lock of the entrance arrangement of the pet stroller according to the preferred embodiment of the present invention.

FIG. 7 is a partial perspective view illustrating a step panel of the entrance arrangement of the pet stroller at a storage position according to the above preferred embodiment of the present invention.

FIG. 8 is a partial perspective view illustrating the step panel of the entrance arrangement of the pet stroller at a pull-out position according to the above preferred embodiment of the present invention.

FIG. 9 is a bottom perspective view of the step panel of the entrance arrangement of the pet stroller according to the above preferred embodiment of the present invention.

FIG. 10 is a partial perspective view illustrating a shading device of the pet stroller according to the above preferred embodiment of the present invention.

FIG. 11 is a partial perspective view illustrating a rear wheel braking system of the pet stroller according to the above preferred embodiment of the present invention.

FIGS. 12A and 12B are perspective views illustrating a handle frame of the pet stroller according to the above preferred embodiment of the present invention.

FIG. 13 is a perspective view of a pet stroller according to an alternative mode of the above preferred embodiment of the present invention.

FIGS. 14A and 14B are perspective views illustrating an entrance arrangement of the pet stroller according to the alternative mode of the above preferred embodiment of the present invention.

FIG. 15 is a partial perspective view of a front entrance member of the entrance arrangement of the pet stroller according to the alternative mode of the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

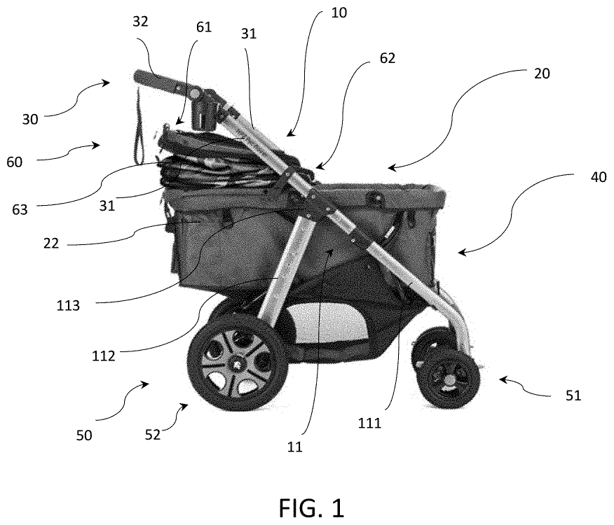

Referring to FIGS. 1 to 11, a pet stroller according to a preferred embodiment of the present invention is illustrated, wherein the pet stroller is transportation tool for pushing a pet, such as a dog, around. According to the preferred embodiment, the pet stroller comprises a stroller frame and an entrance arrangement 40.

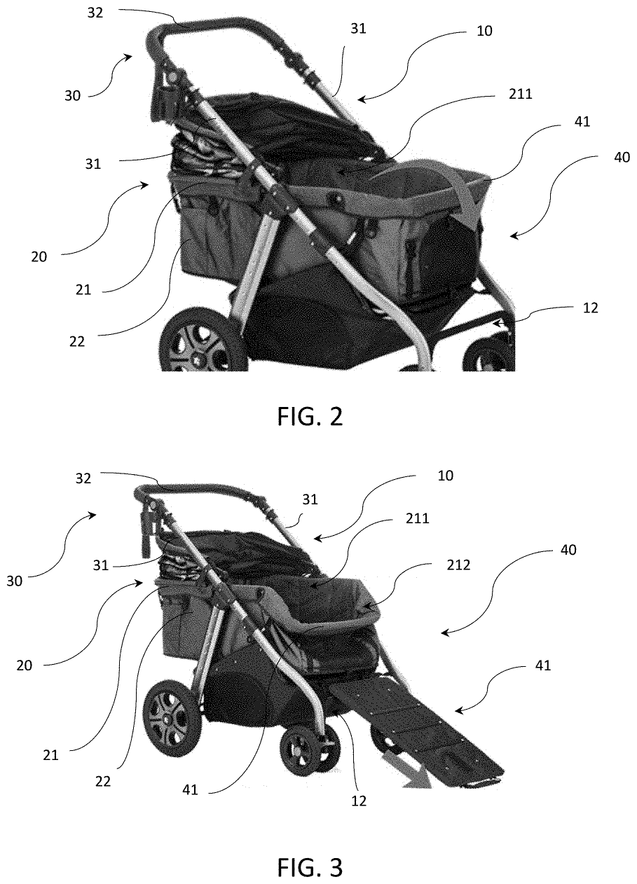

The stroller frame comprises a foldable frame 10, a boundary frame 20 supported by the foldable frame 10, and a handle frame 30 upwardly extended from the foldable frame, wherein the boundary frame 20 comprises a U-shaped boundary member 21 defining a pet seating area 211 and a front entrance 212, as shown in FIGS. 2 and 3.

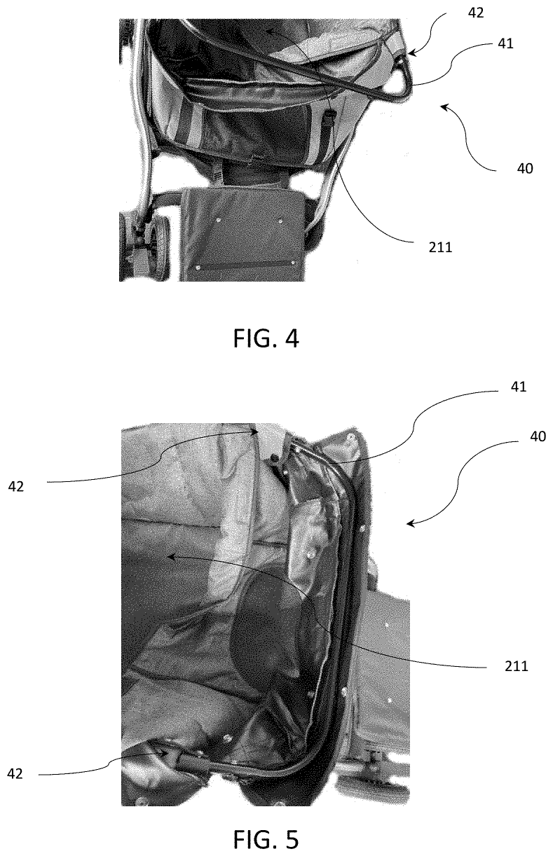

Referring to FIGS. 2 to 5, the entrance arrangement 40 comprises a front entrance member 41 movably coupled at two front ends of the boundary member 21 respectively to move between an uplift position as shown in FIGS. 2 and 4, and a drop down position as shown in FIGS. 3 and 5. At the uplift position, the front entrance member 41 is lifted upwardly, embodied to be parallel to the boundary member 21, to form a front boundary of the boundary frame 20 for blocking the front entrance 212, and at the drop down position, the front entrance member 21 is dropped down to enlarge the front entrance 212 for accessing the pet seating area 211.

As shown in FIG. 1, the foldable frame 10 comprises a pair of side frames 11 each comprising a front folding arm 111 and a rear folding arm 112 pivotally coupling with the front folding arm 111 via a folding joint 113, such that the side frames 11 are folded when the front and rear folding arms 111, 112 are pivotally moved toward each other. On the other hand, the side frames 11 are unfolded when the front and rear folding arms 111, 112 are pivotally moved away from each other to form a V-shaped configuration.

The boundary frame 20 further comprises a pet basket 22 supported by the boundary member 21 to define the pet seating area 211 within the pet basket 22, wherein the pet basket 22 is suspended and mounted between the side frames 11 of the foldable frame 10. Accordingly, the pet basket 22 has a top basket rim to define a top opening, wherein the boundary member 21 is coupled at a rear portion of the top basket rim while the front entrance member 41 is coupled at a front portion of the top basket rim. Therefore, when the front entrance member 21 is lifted upward at its uplift position as shown in FIG. 2, a front wall of the pet basket 22 is stretched in a tension manner to block at the front entrance 212. When the front entrance member 21 is dropped down at its drop down position as shown in FIG. 3, the front wall of the pet basket 22 is collapsed to open up the front entrance 212. It is worth mentioning that the pet basket 22 has a bottom wall made of rigid material to serve as a supportive seating wall at the pet seating area for allowing the pet resting on the bottom wall of the pet basket 22.

Referring to FIGS. 1 and 12A-12B, the handle frame 30 comprises two handle side members 31 upwardly extended from the foldable frame 10 and a U-shaped handle top member 32 pivotally coupled at two top ends of the handle side members 31, referring to FIGS. 2 and 3, such that the handle top member 32 is pivotally adjustable with respect to the foldable frame 10 in an ergonomic manner. Accordingly, the handle side members 31 are pivotally coupled at the side frames 11 of the folding frame 10 respectively. Particularly, bottom ends of the handle side members 31 are pivotally coupled at the front folding arms 111 via the folding joints 113 respectively. The handle top member 32 can be pivotally and upwardly moved to elevate a handle portion of the handle top member 32 from the ground, as shown in FIGS. 2 and 12A. Likewise, the handle top member 32 can be pivotally and downwardly move to reduce a distance between the handle portion of the handle top member 32 and the ground, as shown in FIGS. 3 and 12B. Therefore, the user is able to adjust the handle top member 32 to move the pet stroller in an ergonomic manner.

According to the preferred embodiment, the front entrance member 41, having a U-shaped configuration, has two ends pivotally connected to the front ends of the boundary member 21 respectively, such that the front entrance member 41 is pivotally moved up to the uplift position, as shown in FIG. 4, and is pivotally moved down to the drop down position, as shown in FIG. 5. It is worth mentioning that the U-shaped boundary member 21 and the U-shaped front entrance member 41 are pivotally coupled with each other end-to-end to form a boundary of the pet resting area 211. In other words, the boundary member 21 forms a rear boundary of the pet resting area 211 while the front entrance member 41 forms a front boundary of the pet resting area 211.

Furthermore, the front portion of the pet basket 22 is coupled and supported at the front entrance member 41. Therefore, the front entrance member 41 is pivotally lifted at its uplift position to stretch the front wall of the pet basket 22 so as to block at the front entrance 212, as shown in FIG. 4. The front entrance member 41 is pivotally dropped at its drop down position to collapse the front wall of the pet basket 22 to open up the front entrance 212, as shown in FIG. 5.

Referring to FIGS. 4 to 6, the entrance arrangement 40 further comprises two frame lockers 42 coupling the ends of the front entrance member 41 at the front ends of the boundary member 21 respectively to lock up the front entrance member 41 between the uplift position and the drop down position. Accordingly, each of the frame lockers 42 is constructed to have a locking button 420 arranged in such a manner that when the locking button 420A is actuated or pressed, the frame locker 42 is unlocked to enable the front entrance member 41 to pivotally move with respect to the boundary member 21. In one embodiment, the frame lockers 42 further serve as the pivot joints for pivotally connecting the ends of the front entrance member 41 with the front ends of the boundary member 21. Preferably, the frame lockers 42 are arranged to only lock up the front entrance member 41 at the uplift position. In other words, the front entrance member 41 is locked at the uplift position to prevent the front entrance member 41 being moved accidentally or unintentionally. The front entrance member 41 is free to move from the drop down position to the uplift position. It is worth mentioning that the front entrance member 41 is unlocked when the locking buttons of the frame lockers 42 are actuated or pressed at the same time.

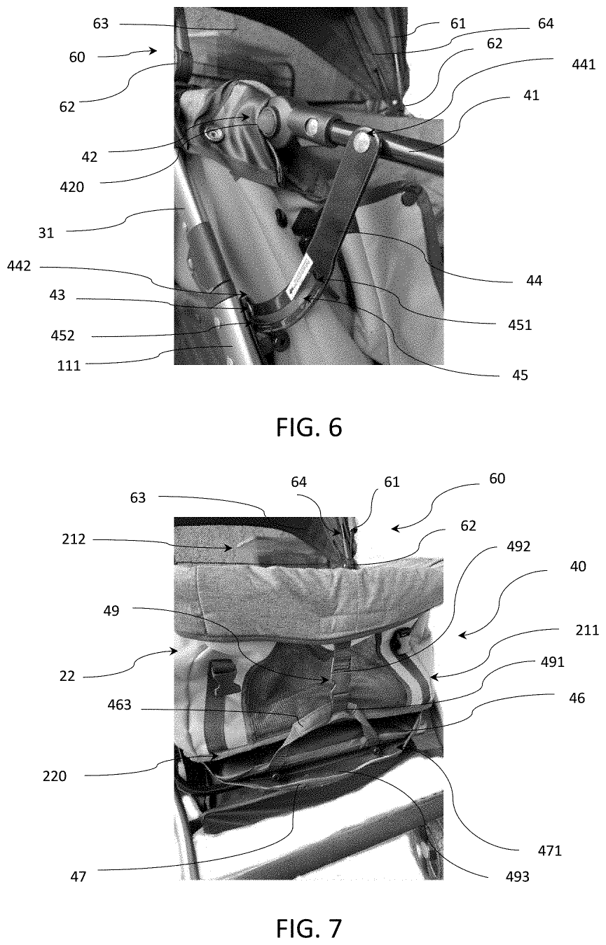

Referring to FIG. 6, the entrance arrangement 40 further comprises two guiding sliders 43 provided at two sides of the foldable frame 10 and two guiding arms 44 pivotally coupled at two side portions of the front entrance member 41 to slidably engage with the guiding sliders 43 respectively for guiding the front entrance member 41 being moved between the uplift position as shown in FIG. 4 and the drop down position as shown in FIG. 5.

According to the preferred embodiment, the guiding sliders 43 are coupled at the front folding arms 111 of the side frames 11 respectively and are alignedly extended toward each other.

As shown in FIGS. 4 to 6, each of the guiding arms 44 has a first pivot end 441 pivotally coupled at the front entrance member 41 and a second free end 442 extended toward the front folding arm 111 of the side frame 11. Each of the guiding arms 44 further has a sliding slot 45 formed between the first pivot end and the second free end for the guiding slider 43 engaging therewithin, such that the guiding sliders 43 are slid along the sliding slots 45 respectively to guide the front entrance member 41 moving between the uplift position and the drop down position.

In one embodiment, each of the sliding slots 45 has a curvature matching with a pivot displacement of the front entrance member 41, wherein when the guiding sliders 43 are slid along the sliding slots 45 respectively, the front entrance member 41 is guided to move between the uplift position and the drop down position.

Particularly, each of the sliding slots 45 has a first end 451 and an opposed second end 452 defining a length of the sliding slot 45 between the first end 451 and the second end 452. The length of the sliding slot 45 is defined as a traveling displacement of the front entrance member 41. In other words, when the guiding sliders 43 are slid at the first end 451 of the sliding slots 45 respectively, the front entrance member 41 is moved at the drop down position. When the guiding sliders 43 are slid at the second end 452 of the sliding slots 45 respectively, the front entrance member 41 is moved at the uplift position.

As shown in FIGS. 4 and 5, the second end 452 of each of the sliding slots 45 has a L-shaped configuration, wherein when the guiding sliders 43 are slid at the second end 452 of the sliding slots 45 respectively, the front entrance member 41 is locked at the uplift position. Particularly, the L-shaped second end 452 of the sliding slot 45 defines a slot locking portion at a closed end and a slot releasing portion extended from the slot locking portion to communicate with the first end 451. When the guiding slider 43 is slid at the slot locking portion of the second end 452 of the sliding slot 45, the guiding slider 43 is locked to lock up the front entrance member 41 at the uplift position. When the guiding slider 43 is moved from the slot locking portion to the slot releasing portion of the second end 452 of the sliding slot 45, the guiding slider 43 is free to slide along the sliding slot 45 so as to move the front entrance member 41 from the uplift position to the drop down position. In order to move the guiding slider 43 from the slot locking portion to the slot releasing portion of the second end 452 of the sliding slot 45, the second free end of the guiding arm 44 is actuated or pressed to release the guiding slider 43 at the slot locking portion of the sliding slot 45. Preferably, the second end 452 of the sliding slot 45 is formed at the second free end of the guiding arm 44 while the first end 451 of the sliding slot 45 is formed toward the first pivot end of the guiding arm 44.

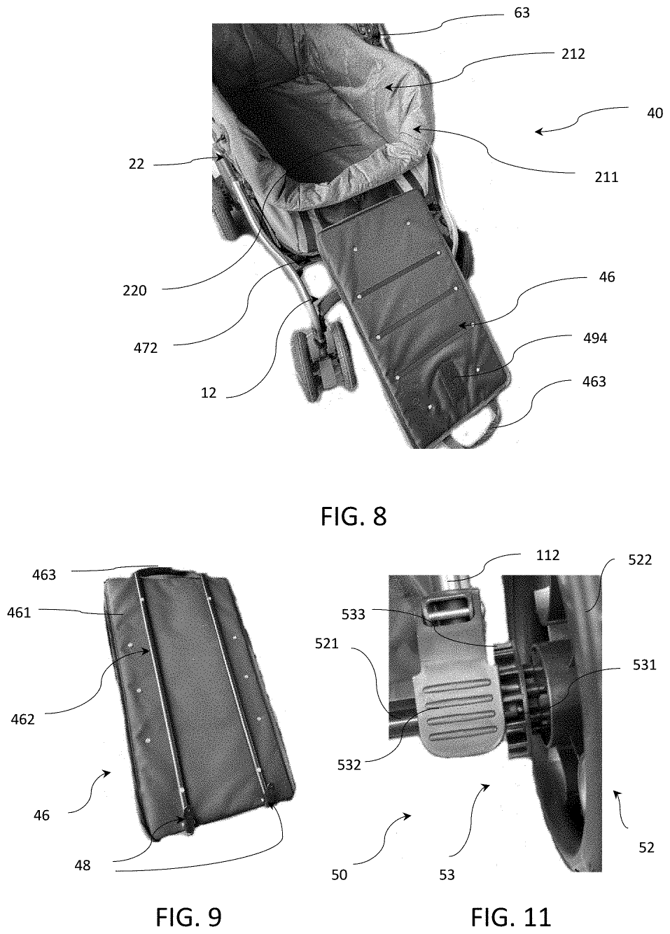

As shown in FIGS. 3 and 7 to 9, the entrance arrangement 40 further comprises a step panel 46 received under the pet seating area 212 when it is not in use, and frontwardly extended from the pet entrance 211 at a pull-out position for allowing the pet walking on the step panel 46 to the pet seating area 212. In one embodiment, the step panel 46 comprises a panel member 461 having a rectangular shape corresponding to the shape of a bottom wall 220 of the pet basket 22 and a panel frame 462 supporting the panel member 461 thereunder, as shown in FIG. 9. The step panel 46 is received under the bottom wall 220 of the pet basket 22 when it is not in use. The step panel 46 is arranged to pull until a front edge of the step panel 46 is rested on the ground while a rear edge of the step panel 46 is placed at the front entrance 211, such that the step panel 46 serves as a walkway for the pet to walk to the pet resting area 212 from the ground or to walk out of the pet resting area 212, as shown in FIG. 8. In other words, the step panel 46 is made of rigid material to support the pet walking thereon.

In order to hide the step panel 46 when it is not in use, i.e. at a storage position, the entrance arrangement 40 further comprises a pocket layer 47 connected underneath the bottom wall 220 of the boundary frame 20 to form a panel pocket 471 having a front pocket opening to receive the step panel 46 in the panel pocket 47. Accordingly, the pocket layer 47 is overlapped at the bottom wall of the pet basket 22 to form the panel pocket 471 between the pocket layer 47 and the bottom wall of the pet basket 22. It is appreciated that the configuration of the panel layer 47 and the panel pocket 471 not only allows the step panel 46 to be received in the panel pocket 471 when it is not use, but also provides an additional support to the pet backet 22 to support the pet accommodated in the pet seating area 212.

Referring to FIGS. 8 and 9, the entrance arrangement 40 further comprises a retention strap 472 extended from the panel pocket 471 and a strap fastener 473 detachably fastening a free end of the retention strap 472 to the rear edge of the step panel 46. When the step panel 46 is slid out of the panel pocket 471, the step panel 46 is restricted by a length of the retention strap 472 to retain the rear edge of the step panel 46 at the front entrance 211 of the boundary frame 20. Accordingly, the retention strap 472 is a length-adjustable strap adapted to selectively adjust its length, wherein one end of the retention strap 472 is affixed into an inner wall of the panel pocket 471 while a free end of the retention strap 472 is coupled to the strap fastener 473. In one embodiment, the strap fastener 473 is buckle and socket fasteners provided at the free end of the retention strap 472 and the rear edge of the step panel 46. It is worth mentioning that the step panel 46 can be detached from the stroller frame via the strap fastener 473.

The entrance arrangement 40 further comprises at least a hooking element 48 provided at a bottom side of the step panel 46 at the rear edge thereof, wherein the hooking element 48 is detachably hooked at the foldable frame 10 to further retain the rear edge of the step panel 46 at the front entrance 211 of the boundary frame 20. In one embodiment, two hooking elements 48 are spacedly provided at the bottom side of the step panel 46. When the step panel 46 is pulled out of the panel pocket 471 and is restricted by the retention strap 472, the hooking elements 48 can be hooked at a cross bar 12 of the foldable frame 10 to securely support the step panel 46 by the foldable frame 10, as shown in FIG. 3. In other words, the slide-out position of the step panel 46 is retained by the retention strap 472 and the step panel 46 is supported by the foldable frame 10, such that the step panel 46 is securely retained for the pet walking thereon. In one embodiment, referring to FIGS. 3 and 8, the cross bar is extended between the front folding arms 111 of the side frames 11 at a position below the front entrance 211. It is worth mentioning that when the strap fastener 473 is unfastened to detach the step panel 46 from the panel pocket 471, the hooking elements 48 can be hooked at the pivotally dropped down front entrance member 41, such that the step panel 46 can be selectively coupled at different locations of the foldable frame 10 to selectively adjust an inclination angle of the step panel 46 to the ground. For example, the step panel 46 can be coupled at the upper cross bar to retain the rear edge of the step panel 46 right below the front entrance 211 for a smaller dog to walk on the step panel 46 to the pet resting area 212. When the step panel 46 can be coupled at the lower cross bar to keep the step panel 46 close to the ground for a bigger dog walk on the step panel 46 to the pet resting area 212.

Referring to FIG. 7, the entrance arrangement 40 further comprises a panel holder 49 provided at the front edge of the step panel 46 to releasably fasten the step panel 46 at the boundary frame 20 so as to prevent the step panel 46 received in the panel pocket 471 being slid out of the panel pocket 472 accidently. Accordingly, the step panel 46 has a handle strap 463 affixed to the front edge of the step panel 46 to pull the step panel 46 out of the panel pocket 472. The panel holder 49 has a first holder 491 provided at the handle strap 463 of the step panel 46 and a second holder 492 provided at the front wall of the pet basket 22, wherein the first and second holders 491, 492 are detachably fastened with each other to retain the step panel 46 in the panel pocket 472. Once the first and second holders 491, 492 are detached with each other, the step panel 46 can be pulled out of the panel pocket 472. In one embodiment, the first and second holders 491, 492 are buckle and socket fasteners.

Referring to FIGS. 7 and 8, the entrance arrangement 40 further comprises a first pocket locker 493 provided at a bottom side of the boundary frame 20 and a second pocket locker 494 provided on a top side of the step panel 46 to detachably fasten with the first pocket locker 493 so as to retain the step panel 46 in the panel pocket 472. The first pocket locker 493 is provided at a bottom side of the bottom wall of the pet basket 22 at a position close to the front entrance 211. The second pocket locker 494 is provided at the top side of the step panel 46 at a position close to the front edge thereof. In one embodiment, the first and second pocket lockers 493, 494 are hook-and-loop fasteners.

As shown in FIGS. 1 and 11, the pet stroller further comprises a wheel assembly 50. The wheel assembly 50 comprises a front wheel unit 51 and a rear wheel unit 52. In one embodiment, the front wheel unit 51 comprises two front wheels rotatably coupled at bottom ends of the front folding arms 111 respectively. The rear wheel unit 52 comprises a rear wheel axle 521 coupled at the foldable frame 10, and at least a rear wheel 522 rotatably coupled at the rear wheel axle 521. In one embodiment, the rear wheel axle 521 is coupled at bottom ends of the rear folding arms 112, wherein two rear wheels 522 are rotatably coupled at two ends of the rear wheel axle 521.

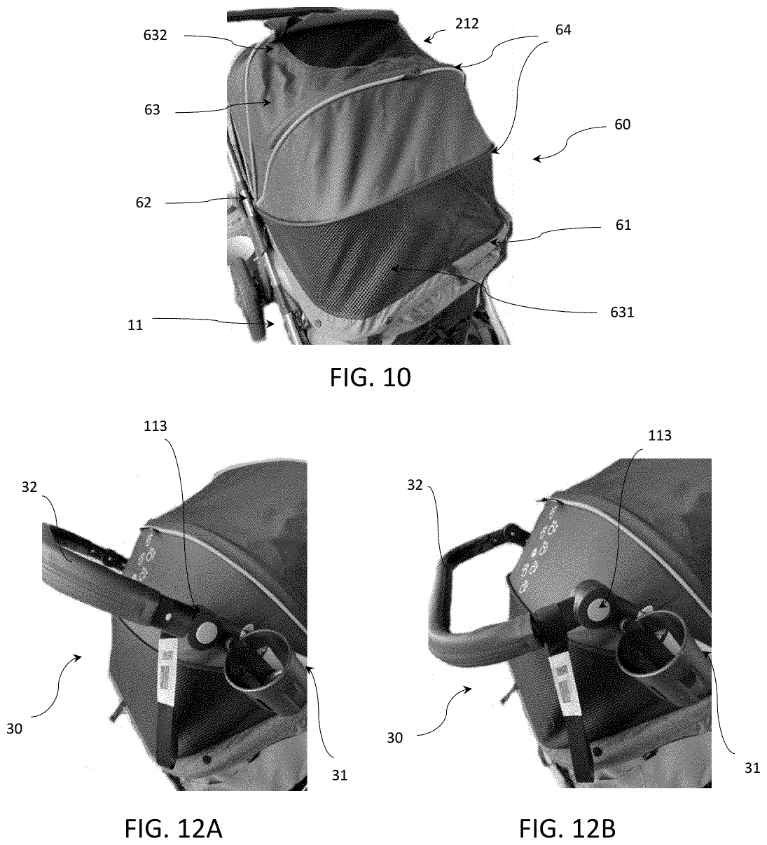

According to the preferred embodiment, the wheel assembly 50 further comprises a rear wheel braking system 53 for controlling a rotation of the rear wheel 522, as shown in FIG. 10. Accordingly, the rear wheel braking system 53 comprises at least a braking gear 531 coaxially coupled at one or the rear wheels 522 and a foot brake 532 pivotally coupled at the foldable frame 10 and arranged in such a manner that the foot brake 532 is pivotally pressed to engage with the braking gear 531 for locking up the rotation of the rear wheel 522 and is pivotally lifted up to disengage with the braking gear 531 for enabling the rear wheel 522 being rotated. The braking gear 531 is coupled at the end of the rear wheel axle 521 to coaxially couple at the rear wheel 522. The foot brake 532 which is pivotally coupled at the rear folding arm 112 comprises a brake arm 533 configured to selectively engage with the braking gear 531 to block and lock the rotation of the rear wheel 522.

As shown in FIGS. 1, 6-7 and 10, the pet stroller further comprises a shading frame 60 detachably coupled at the foldable frame 10 at a position above the boundary frame 20 to selective shade the pet resting area 212. In one embodiment, the shading frame 60 comprises a plurality of U-shaped awning arms 61, two pivot joints 62 pivotally coupling with ends of the awning arms 61, and a canopy 63 supported by the awning arms 61. Accordingly, the pivot joints 62 are detachably coupled at the side frames 11 of the foldable frame 10 respectively.

In one embodiment, two pairs of awning arms 61 are provided, wherein a pair of awning arms 61 are two outer awning arms 61 while another pair of awning arms 61 are two inner awning arms 61. When the ends of the awning arms 61 are pivotally coupled at the pivot joints 62, the awning arms 61 are extended between the side frames 11 to across the pet resting area 212. Accordingly, the awning arms 61 are pivotally moved at the pivot joints 62 to selectively expand the canopy 63 to one of a full shading position for fully shading the pet resting area 212, a half shading position for partially shading the pet resting area 212, and an exposing portion for uncovering the pet resting area 212. In one example, when the awning arms 61 are pivotally moved to fully stretch the canopy 63, the canopy 63 is expanded at the full shading position. By adjusting a distance between every two of the awning arms 61, the shading area of the canopy 63 can be selectively configured. Once the awning arms 61 are overlapped with each other, the canopy 63 is folded up fully expose the pet resting area 212.

The shading frame 60 further comprises a plurality of awning retention ribs 64 spacedly affixed to the canopy to retain a shape of the canopy 63 in a tension manner. Accordingly, the awning retention ribs 64, each having a U-shaped, are located alternating with the awning arms 61. It is worth mentioning that the awning arms 61 are coupled at an inner side of the canopy 63 while the awning retention ribs 64 are coupled at an outer side of the canopy 63. Furthermore, the shading frame 60 further comprises a front canopy window 631 formed on the canopy 63 for allowing light passing through the canopy window to the pet resting area 212, especially when the canopy 63 is expanded at the full shading position and a top canopy window 632 which is openable for the user to access the pet accommodated in the pet resting area 212.

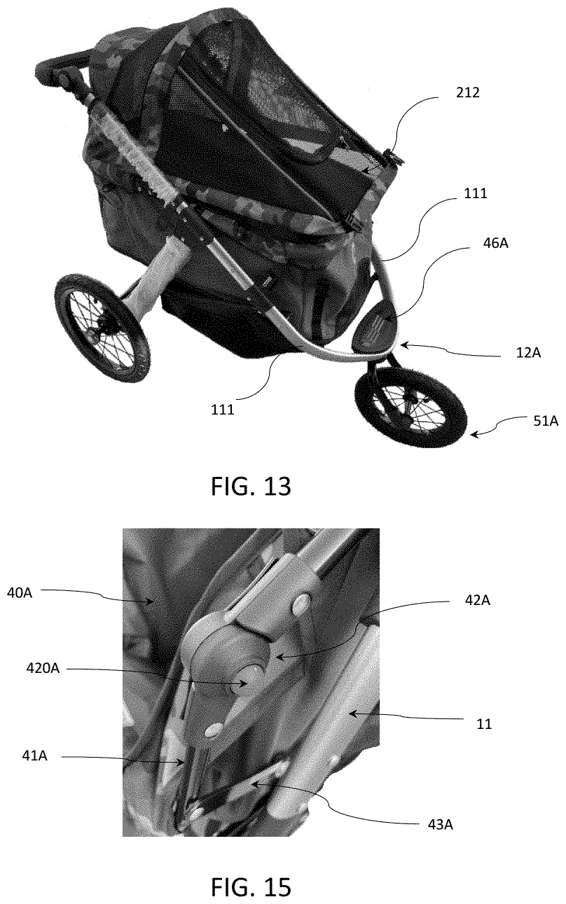

FIG. 13 illustrates an alternative mode of the pet stroller, especially for smaller and more active pet of the above preferred embodiment of the present invention. In the modification, the step panel 46A is coupled at the cross bar of the foldable frame 10 for allowing the pet walking on the step panel 46A to the pet seating area 212. The cross bar 12A is integrally extended between the bottom ends of the front folding arms 111. Accordingly, the step panel 46A is an enlarged panel securely coupled at the cross bar 12A to support the step panel 46A between the side frames 11 of the foldable frame 10. Therefore, the step panel 46A serves as a stepping stool between the pet resting area 212 and the ground for help the pet stepping on the step panel 46 to get in-and-out the pet resting area 212.

Furthermore, the front wheel unit 51A is modified to have one front wheel rotatably coupled at the cross bar of the foldable frame 10, wherein the front wheel of the front wheel unit 51A is located underneath the step panel 46A. In other words, the pet stroller is a three-wheel stroller in the modification.

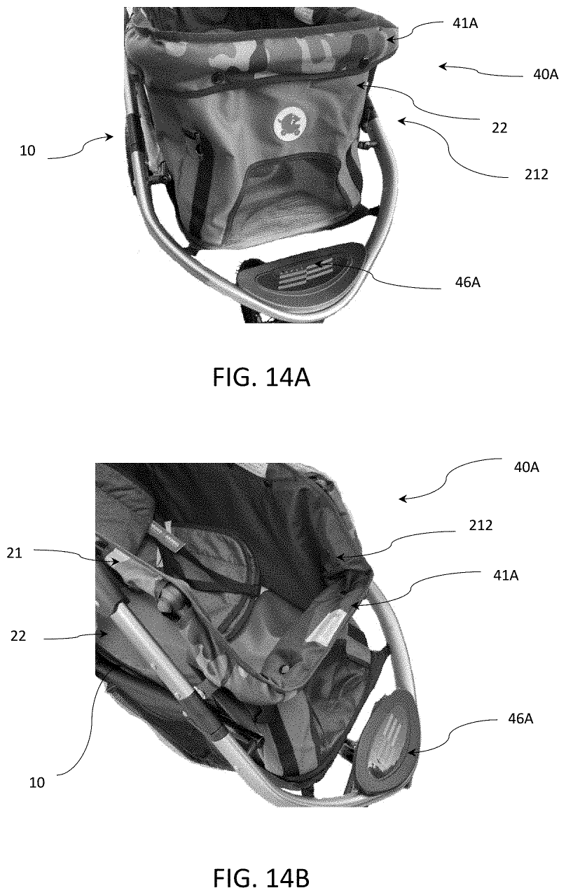

As shown in FIGS. 14A-14B, the entrance arrangement 40A of the pet stroller comprises the front entrance member 41A pivotally coupled at the two front ends of the boundary member 21 of the foldable frame 10 to selectively move between an uplift position, as shown in FIG. 14A, to block the front entrance 212, and a drop down position, as shown in FIG. 14B to enlarge the front entrance 212. In one embodiment, the front entrance member 41A of the entrance arrangement 40A, having a U-shaped configuration, has two side ends pivotally coupled at the side frames 11 respectively. Accordingly, when the entrance member 41A is pivotally moved downward, a front portion of the bottom wall of the pet basket 22 is dropped down, such that the front entrance 211 is dropped down to adjust the entrance angle of the front entrance 211 at an inclined manner at a horizontal manner. When the entrance member 41A is pivotally moved upward, the front portion of the bottom wall of the pet basket 22 is lifted up, such that the front entrance 211 is elevated to adjust the entrance angle of the front entrance 211 at a horizontal manner.

Further referring to FIG. 15, the entrance arrangement 40A also comprises two frame lockers 42A coupling the ends of the front entrance member 41A at the front ends of the boundary member 21 respectively to lock up the front entrance member 41A between the uplift position and the drop down position. Each of the frame lockers 42A is constructed to have a locking button 420A arranged in such a manner that when the locking button 420A is actuated or pressed, the frame locker 42A is unlocked to enable the front entrance member 41A to pivotally move with respect to the boundary member 21. The frame lockers 42A further serve as the pivot joints for pivotally connecting the ends of the front entrance member 41A with the front ends of the boundary member 21. Preferably, the frame lockers 42A are arranged to only lock up the front entrance member 41A at the uplift position. In other words, the front entrance member 41A is locked at the uplift position to prevent the front entrance member 41A being moved accidentally or unintentionally. The front entrance member 41A is free to move from the drop down position to the uplift position. It is worth mentioning that the front entrance member 41A is unlocked when the locking buttons of the frame lockers 42A are actuated or pressed at the same time.

The entrance arrangement 40A further comprises two guiding arms 43A having one ends pivotally connected at two side frames 11 of the foldable frame 10 respectively and another ends respectively and pivotally connected with two sides of the entrance member 41A respectively, so as to guide the movement of the uplighting and dropping down of the entrance member 41A.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A pet stroller for a pet, comprising:
a stroller frame which comprises a foldable frame, a boundary frame supported by said foldable frame, and a handle frame upwardly extended from said foldable frame, wherein said boundary frame comprises a U-shaped boundary member defining a pet seating area and a front entrance; and
an entrance arrangement which comprises a front entrance member movably coupled at two front ends of said boundary member respectively to move between an uplift position and a drop down position, wherein at said uplift position, said front entrance member is lifted upwardly to form a front boundary of said boundary frame for blocking said front entrance, and at said drop down position, said front entrance member is dropped down to enlarge said front entrance for accessing said pet seating area.

2. The pet stroller, as recited in claim 1, wherein said front entrance member, having a U-shaped configuration, has two ends pivotally connected to said front ends of said boundary member respectively, such that said front entrance member is pivotally moved up to said uplift position and is pivotally moved down to said drop down position.

3. The pet stroller, as recited in claim 2, wherein said entrance arrangement further comprises two frame lockers coupling said ends of said front entrance member at said front ends of said boundary member respectively to lock up said front entrance member between said uplift position and said drop down position.

4. The pet stroller, as recited in claim 2, wherein said entrance arrangement further comprises two guiding sliders provided at two sides of said foldable frame and two guiding arms pivotally coupled at two side portions of said front entrance member to slidably engage with said guiding sliders respectively for guiding said front entrance member being moved between said uplift position and said drop down position.

5. The pet stroller, as recited in claim 4, wherein each of said guiding arms has a sliding slot for said guiding slider engaging therewithin, wherein each of said sliding slots has a curvature matching with a pivot displacement of said front entrance member, such that said guiding sliders are slid along said sliding slots respectively to guide said front entrance member moving between said uplift position and said drop down position.

6. The pet stroller, as recited in claim 5, wherein each of said sliding slots has a first end and an opposed second end having a L-shaped configuration, wherein when said guiding sliders are slid at said first ends of said sliding slots respectively, said front entrance member is moved at said drop down position, and when said guiding sliders are slid at said second ends of said sliding slots respectively, said front entrance member is moved and locked at said uplift position.

7. The pet stroller, as recited in claim 2, wherein said boundary frame further comprises a pet basket having a top basket rim, wherein a rear portion of said top basket rim is coupled at said boundary member while a front portion of said top basket rim is coupled at said front entrance member, such that when said front entrance member is moved up to said uplift position, a front wall of said pet basket is stretched in a tension manner to block at said front entrance, and when said front entrance member is moved down to said drop down position, said front wall of said pet basket is collapsed to open up said front entrance.

8. The pet stroller, as recited in claim 6, wherein said boundary frame further comprises a pet basket having a top basket rim, wherein a rear portion of said top basket rim is coupled at said boundary member while a front portion of said top basket rim is coupled at said front entrance member, such that when said front entrance member is moved up to said uplift position, a front wall of said pet basket is stretched in a tension manner to block at said front entrance, and when said front entrance member is moved down to said drop down position, said front wall of said pet basket is collapsed to open up said front entrance.

9. The pet stroller, as recited in claim 1, wherein said entrance arrangement further comprises a step panel received under said pet seating area when it is not in use, and frontwardly extended from said pet entrance for allowing the pet walking on said step panel to said pet seating area.

10. The pet stroller, as recited in claim 8, wherein said entrance arrangement further comprises a step panel received under said pet seating area when it is not in use, and frontwardly extended from said pet entrance for allowing the pet walking on said step panel to said pet seating area.

11. The pet stroller, as recited in claim 9, wherein said entrance arrangement further comprises a pocket layer overlapped underneath a bottom of said boundary frame to form a panel pocket having a front pocket opening to receive said step panel in said panel pocket.

12. The pet stroller, as recited in claim 10, wherein said entrance arrangement further comprises a pocket layer overlapped underneath a bottom of said boundary frame to form a panel pocket having a front pocket opening to receive said step panel in said panel pocket.

13. The pet stroller, as recited in claim 11, wherein said entrance arrangement further comprises a retention strap extended from said panel pocket and a strap fastener detachably fastening a free end of said retention strap to a rear edge of said step panel, such that when said step panel is slid out of said panel pocket, said step panel is restricted by a length of said retention strap to retain said rear edge of said step panel at said front entrance of said boundary frame.

14. The pet stroller, as recited in claim 12, wherein said entrance arrangement further comprises a retention strap extended from said panel pocket and a strap fastener detachably fastening a free end of said retention strap to a rear edge of said step panel, such that when said step panel is slid out of said panel pocket, said step panel is restricted by a length of said retention strap to retain said rear edge of said step panel at said front entrance of said boundary frame.

15. The pet stroller, as recited in claim 13, wherein said entrance arrangement further comprises at least a hooking element provided at a bottom side of said step panel at said rear edge thereof, wherein said hooking element is detachably hooked at said foldable frame to further retain said rear edge of said step panel at said front entrance of said boundary frame.

16. The pet stroller, as recited in claim 14, wherein said entrance arrangement further comprises at least a hooking element provided at a bottom side of said step panel at said rear edge thereof, wherein said hooking element is detachably hooked at said foldable frame to further retain said rear edge of said step panel at said front entrance of said boundary frame.

17. The pet stroller, as recited in claim 15, wherein said entrance arrangement further comprises a panel holder provided at a front edge of said step panel to releasably fasten said step panel at said boundary frame so as to prevent said step panel being slid out of said panel pocket.

18. The pet stroller, as recited in claim 16, wherein said entrance arrangement further comprises a panel holder provided at a front edge of said step panel to releasably fasten said step panel at said boundary frame so as to prevent said step panel being slid out of said panel pocket.

19. The pet stroller, as recited in claim 17, wherein said entrance arrangement further comprises a first pocket locker provided at said bottom side of said boundary frame and a second pocket locker provided on a top side of said step panel to detachably fasten with said first pocket locker so as to retain said step panel in said panel pocket.

20. The pet stroller, as recited in claim 18, wherein said entrance arrangement further comprises a first pocket locker provided at said bottom side of said boundary frame and a second pocket locker provided on a top side of said step panel to detachably fasten with said first pocket locker so as to retain said step panel in said panel pocket.

21. The pet stroller, as recited in claim 1, further comprising a shading frame detachably coupled at said foldable frame at a position above said boundary frame to selective shade said pet resting area, wherein said shading frame comprises a plurality of U-shaped awning arms, two pivot joints pivotally coupling with ends of said awning arms, and a canopy supported by said awning arms, such that said awning arms are pivotally moved at said pivot joints to selectively expand said canopy to one of a full shading position for fully shading said pet resting area, a half shading position for partially shading said pet resting area, and an exposing portion for uncovering said pet resting area.

22. The pet stroller, as recited in claim 20, further comprising a shading frame detachably coupled at said foldable frame at a position above said boundary frame to selective shade said pet resting area, wherein said shading frame comprises a plurality of U-shaped awning arms, two pivot joints pivotally coupling with ends of said awning arms, and a canopy supported by said awning arms, such that said awning arms are pivotally moved at said pivot joints to selectively expand said canopy to one of a full shading position for fully shading said pet resting area, a half shading position for partially shading said pet resting area, and an exposing portion for uncovering said pet resting area.

23. The pet stroller, as recited in claim 21, wherein said shading frame further comprises a plurality of awning retention ribs spacedly affixed to said canopy to retain a shape of said canopy in a tension manner, wherein said awning retention ribs are located alternating with said awning arms.

24. The pet stroller, as recited in claim 22, wherein said shading frame further comprises a plurality of awning retention ribs spacedly affixed to said canopy to retain a shape of said canopy in a tension manner, wherein said awning retention ribs are located alternating with said awning arms.

25. The pet stroller, as recited in claim 23, wherein said shading frame further comprises a canopy window formed on said canopy.

26. The pet stroller, as recited in claim 24, wherein said shading frame further comprises a canopy window formed on said canopy.

27. The pet stroller, as recited in claim 1, wherein said handle frame comprises two handle side members upwardly extended from said foldable frame and a U-shaped handle top member pivotally coupled at two top ends of said handle side members, such that said handle top member is pivotally adjustable with respect to said foldable frame in an ergonomic manner.

28. The pet stroller, as recited in claim 26, wherein said handle frame comprises two handle side members upwardly extended from said foldable frame and a U-shaped handle top member pivotally coupled at two top ends of said handle side members, such that said handle top member is pivotally adjustable with respect to said foldable frame in an ergonomic manner.

27. The pet stroller, as recited in claim 1, wherein said stroller frame further comprises front and rear wheel units rotatably coupled at said foldable frame below said boundary frame, and a rear wheel braking system operatively coupled at said rear wheel unit for selectively lock up a rotation of said rear wheel unit.

28. The pet stroller, as recited in claim 28, wherein said stroller frame further comprises front and rear wheel units rotatably coupled at said foldable frame below said boundary frame, and a rear wheel braking system operatively coupled at said rear wheel unit for selectively lock up a rotation of said rear wheel unit.

29. The pet stroller, as recited in claim 27, wherein said rear wheel unit comprises a rear wheel axle coupled at said foldable frame, and at least a rear wheel rotatably coupled at said rear wheel axle, wherein said rear wheel braking system comprises a braking gear coaxially coupled at said rear wheel and a foot brake pivotally coupled at said foldable frame and arranged in such a manner that said foot brake is pivotally pressed to engage with said braking gear for locking up said rotation of said rear wheel and is pivotally lifted up to disengage with said braking gear for enabling said rear wheel being rotated.

30. The pet stroller, as recited in claim 28, wherein said rear wheel unit comprises a rear wheel axle coupled at said foldable frame, and at least a rear wheel rotatably coupled at said rear wheel axle, wherein said rear wheel braking system comprises a braking gear coaxially coupled at said rear wheel and a foot brake pivotally coupled at said foldable frame and arranged in such a manner that said foot brake is pivotally pressed to engage with said braking gear for locking up said rotation of said rear wheel and is pivotally lifted up to disengage with said braking gear for enabling said rear wheel being rotated.

31. The pet stroller, as recited in claim 1, wherein said foldable frame comprises a cross bar horizontally extended at a position below said boundary frame and in front of said front entrance, wherein said entrance arrangement further comprises a step panel coupled at said cross bar for allowing the pet walking on said step panel to said pet seating area.

32. The pet stroller, as recited in claim 8, wherein said foldable frame comprises a cross bar horizontally extended at a position below said boundary frame and in front of said front entrance, wherein said entrance arrangement further comprises a step panel coupled at said cross bar for allowing the pet walking on said step panel to said pet seating area.

33. The pet stroller, as recited in claim 31, wherein said boundary frame further comprises an entrance control member pivotally coupled at said foldable frame at a position below said front entrance, such that when said entrance control member is pivotally moved downward, said front entrance is dropped down, and when said entrance control member is pivotally moved upward, said front entrance is elevated.

34. The pet stroller, as recited in claim 32, wherein said boundary frame further comprises an entrance control member pivotally coupled at said foldable frame at a position below said front entrance, such that when said entrance control member is pivotally moved downward, said front entrance is dropped down, and when said entrance control member is pivotally moved upward, said front entrance is elevated.
